(19) United States
(12) Patent Application Publication
(10) Pub. No.: US 2003/0061017 A1
(43) Pub. Date: Mar. 27, 2003

(54) Method and a system for simulating the behavior of a network and providing on-demand dimensioning

(75) Inventors: Emmanuel Dotaro, Verrieres Le Buisson (FR); Richard Douville, Bretigny Sur Orge (FR)

Correspondence Address: SUGHRUE MION, PLLC, Suite 800, 2100 Pennsylvania Avenue, N.W., Washington, DC, 20037-3213, US

(73) Assignee: ALCATEL

(21) Appl. No.: 10/253,809

(22) Filed: Sep. 25, 2002

(30) Foreign Application Priority Data
Sep. 27, 2001 (FR) 01 12 450

(51) Int. Cl. G06F 17/50

(52) U.S. Cl. 703/14

(57) ABSTRACT

The invention simulates the behavior of a network including a set of network elements by introducing into the network a parametered flow intended to simulate a constraint on a network element. The flow can model the variation in time of the traffic intensity in the network in relation to the or each element to which a flow is addressed in the context of the simulation, and can feature a modulation on a macroscopic timescale and stochastic fluctuations on a microscopic scale. The invention further provides on-demand dimensioning of a network by uprating, during the simulation, the levels of performance of elements that have manifested a weakness in relation the flow at the time of the simulation. The field of application targets any type of network: circuit mode or packet mode data, electronic or optical networks, and even networks for transporting material or nonmaterial commodities.

The invention provides a simulation method and system for studying and planning networks and providing on-demand network dimensioning if required. It applies to any type of network, e.g. mobile, packet, continuous transmission, and optical networks, for example wavelength division multiplex (WDM) networks, with or without connection to electronic networks, etc.

### BACKGROUND OF THE INVENTION

The simulation can take into account relatively long timescales (for example cycles of one day or more) and a range of dynamic events (traffic, protocol, etc.) associated with control and data plans.

The modeling and simulation of telecommunications systems, to cite one example in which networks are used, is attracting increasing attention because of the complexity of telecommunications systems (high capacity, traffic variability, cost of simulation in a real network). The object is to predict performance, to compare solutions before they are actually implemented, and, more generally, to reduce costs and improve network optimization and dimensioning.

With the convergence of telecommunications and data distribution networks, it is becoming necessary to be able to analyze the high degree of complexity of models in order to evaluate the solutions available and thereby determine the best ways forward.

The prior art uses two approaches to this kind of task, namely a static approach and a packet approach.

The static approach primarily addresses networks that operate in circuit mode, i.e. with continuous data, and uses static simulation matrices. In this case, flows between two points are considered as network entities that do not vary. These tools are therefore unable to capture all the dynamics of the network, the protocols, and the variation of the traffic; at present the traffic variation is the dominant factor.

To be more specific, static tools cannot encompass realistic constraints on optical or electronic resources that relate to the Internet Protocol (IP), for example, or to other packet networks, including constraints due to:

the variation of traffic in time and in space,

dynamic mechanisms: creation of resources and reconfiguration of the network on demand, traffic engineering (load balancing, congestion control, traffic partitioning), network protection or restoration, etc., and

packet transport networks (behavior of peripheral nodes).

As a general rule, static tools are based on optimization methods entailing lengthy calculations, with no real time constraints. These lacunae make themselves felt in the results, which lack consistency and reliability in comparison with reality.

The second approach is called the “packet approach”. Examples of packet approaches can be found in the documents “Optical packet switching with multiple path routing” by Gerardo Castanon, Lubo Tancevski and Lakshman Tamil and “Modeling and simulating communication networks: a hands-on approach using OPNet” by I. Katzela.

Using the packet approach, it is theoretically possible to obtain much more refined analyses which would capture all the parameters of a network. However, because of the number of computations needed, which quickly becomes unacceptable, the problem of computation time arises. In particular, packet modeling cannot be envisaged for simulations relating to “Terabit” networks (which manage more than one terabit (10¹² bits) per second) and traffic variations in the long term (over periods of hours or days), because the absolute number of simulation computations would very much exceed what is currently possible. For example, a packet level simulation for a 100 terabit/s network model evolving over a time scale of 24 hours would necessitate the computation of more than 10¹⁶ events.

The dimensioning of node components based on a packet analysis is therefore generally influenced by considerations applying over only a small radius. However, the quantities of resources (and thus dimensioning and costs) depend primarily on large variations.

Packet analysis cannot be applied to models interworking with networks based on circuits (core behavior considerations), and is limited in the case of networks intended for optical packets.

What is more, the granularity at packet level is too fine to study the network on a realistic timescale. Granularity is a measure of the basic information switched in a network and depends on the network type: for example, it can correspond to the basic wavelength for a wavelength division multiplex network, a fiber in the case of a fiber network, a packet in the case of a packet-switched network, etc. The granularity can be spectral, spatial, temporal, etc.

FIG. 4-6 of the document “Modeling and simulating communication networks: a hands-on approach using OPNet” by I. Katzela shows clearly that the simulation described in that document was effected over a time period of only 30 seconds.

Because of this, conventional network operators analyze a network on a static basis and then proceed to combinatorial optimization, for example using linear conversion or like tools. If they effect a packet analysis, they are able to examine a few nodes at most, and never an entire network, and not with all the protocols that may be used. At best, some succeed in simulating only the control plan, i.e. the signaling between the nodes of the network.

It is therefore impossible to take account of any new protocols or mechanisms for transporting data, for example future optical packets on an optical network.

Using either of the two approaches, it is necessary not only to describe the topology of the network before the simulation, but also to fix the resources in each of the network elements, i.e. the capacity of the links and the equipment of the nodes.

Thus simulation using conventional techniques can take account only of network states during the simulation. It is only after the simulation has been completed and the reports analyzed that it is possible to tell if the design and planning of the network are adapted to the conditions of the simulation scenario.

### OBJECTS AND SUMMARY OF THE INVENTION

Given the foregoing, in a first aspect, the invention consists in a method of simulating the behavior of a network including a set of network elements, wherein the method consists in:

producing and introducing into the network a parametered flow intended to simulate a constraint on a network element, and

detecting the behavior of the network in response to a constraint imposed by said flow.

The flow is preferably produced on the basis of modeling the variation in time of the traffic intensity in the network in relation to the or each element to which a flow is addressed in the context of the simulation.

The flow can then be produced in the form of a set of flows, each member of which set corresponds to the traffic on an elementary path portion connecting a specified respective pair of nodes of the network.

The preferred embodiment of the method includes a step of producing a matrix of flows, each member of which matrix expresses a variation in time of the flow intensity on a respective path portion of the network, the flows being introduced into the network in accordance with said matrix.

A stochastic variation is advantageously imposed on the flow.

The flow can express a traffic intensity variation on a macroscopic timescale relative to its transit time in the network.

This variation can apply to evolutions of flow on a macroscopic timescale simulating several hours of real use of the simulated network, in particular over a daily operating cycle of the network.

An intensity modulation on a macroscopic scale is preferably created for a flow, onto which are imposed local stochastic variations of the flow on a microscopic timescale.

The stochastic variation of the flow can be established in accordance with an exponential distribution, preferably a Poisson distribution.

The flow is preferably characterized by one or more of the following parameters:

a mean bit rate,

the variance of the bit rate,

the Hurst parameter, and

a qualitative parameter, in particular the class of service required by the flow.

A preferred embodiment of the method further includes the steps of:

identifying any weakness of an element faced with said constraint, and

if necessary, modifying an element bearing witness to said weakness to allow it to accommodate the constraint that revealed it, in particular by uprating the dimensioning of a performance characteristic of the element.

This provides on-demand dimensioning of a network or a set of networks.

These detection, identification and modification steps are executed concomitantly with the introduction of flows into the network.

The network element is typically a node and/or a link.

The introduction of flows into the network can be iterated at least once to simulate on each iteration a statistical variation of the flow obtained in particular on the basis of the stochastic nature of the flow.

A second aspect of the invention consists in a method as defined above when executed to establish the dimensioning of the performance of an initially virgin network for which a topology of nodes and links is specified, wherein a flow in relation to which the network must be dimensioned is introduced into the network and said detection, identification and modification steps are carried out until the dimensioning conforming to the flow is obtained.

A third aspect of the invention consists in a method as defined above when executed to establish a new dimensioning of the performance of an existing network, wherein a flow in relation to which it must be dimensioned is introduced into the network and said detection step and where applicable said identification and modification steps are executed until an updated dimensioning conforming to the flow is obtained.

A fourth aspect of the invention consists in a method as defined above when executed to establish a dimensioning of the performance of a network faced with a simulated fault, wherein the network modified by the fault is simulated, a flow in relation to which the network modified in this way must be dimensioned is introduced into the network and said detection step and where applicable said identification and modification steps are executed until there is obtained a dimensioning conforming to the flow on the modified network.

A fifth aspect of the invention consists in a method as defined above when used to simulate a packet mode data transport network.

The flow is preferably produced with an intermediate granularity.

A sixth aspect of the invention consists in a method as defined above when used to simulate a circuit mode data transport network.

A seventh aspect of the invention consists in a device for simulating the behavior of a network including a set of network elements, wherein the device includes:

means for producing and introducing into the network a parametered flow intended to simulate a constraint on a network element, and

means for detecting the behavior of the network in response to a constraint imposed by said flow.

The features of the invention referred to above in the context of a method according to any of the first to sixth aspects of the invention can be applied mutatis mutandis to the above system and for conciseness will not be repeated.

### BRIEF DESCRIPTION OF THE DRAWINGS

The invention and its attendant advantages will become more clearly apparent on reading the detailed description of preferred embodiments which is given by way of non-limiting example only and with reference to the accompanying drawings, in which:

FIG. 1 is a block diagram of functional units used in a flow simulation tool according to the invention with on-demand dimensioning,

FIG. 2A is a diagram showing the nature of the stochastic flows and the sending thereof to a virgin network during the operation of the tool from FIG. 1,

FIG. 2B is a curve showing the evolution in time of the stochastic flow intensity distribution between two nodes of a network to be simulated by the FIG. 1 tool, on a macroscopic timescale corresponding to a simulated cycle duration,

FIG. 2C is a curve showing the evolution of the stochastic flow intensity from FIG. 2B, but on a microscopic scale, of the order of the transit time of a flow in the network, with variations that fluctuate randomly,

FIG. 3 shows the network from FIG. 2A following on-demand dimensioning by the tool from FIG. 1, and

FIG. 4 shows a network analogous to that from FIG. 2A in which a fault is simulated by means of the a tool from FIG. 1.

### MORE DETAILED DESCRIPTION

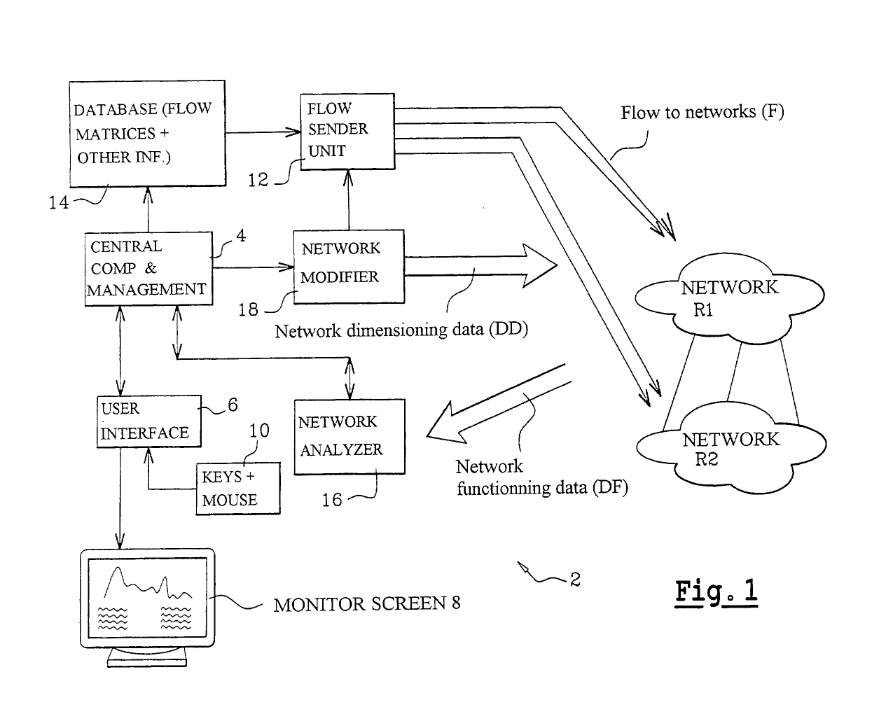

The simulation and dimensioning tool 2 shown in FIG. 1 includes a set of hardware and/or software modules that are functionally dependent on a central computation and management unit 4 which provides the intelligence of the whole system. Access to the tool 2 by a user is effected via a user interface 6 to which are connected a monitor screen 8 and a keyboard associated with a mouse 10.

The central unit 4 controls, among other things, three units which interact with one or more networks R1, R2, namely:

a flow sender unit 12, which transmits traffic simulation data in the form of flows F; the unit 12 is fed by a database 14 containing simulation flow matrices (see below),

a network analyzer unit 16 which collects data DF concerning the functioning of the simulated network(s), and

a network(s) modification unit 18 which transmits network dimensioning data DD, in particular for selectively uprating the performance of network elements as a function of the functioning data DF. This data is used among other things for the on-demand dimensioning of a network during or following a simulation.

The flows F contained in the database 14 are generated by the central unit 4 as a function of criteria and parameters set by an user via the keyboard 10 and the screen 8 of the interface 6, or possibly by a source such as a recording medium or an on-line connection (not shown). Note that the database 14 may contain complementary information in addition to the flows F.

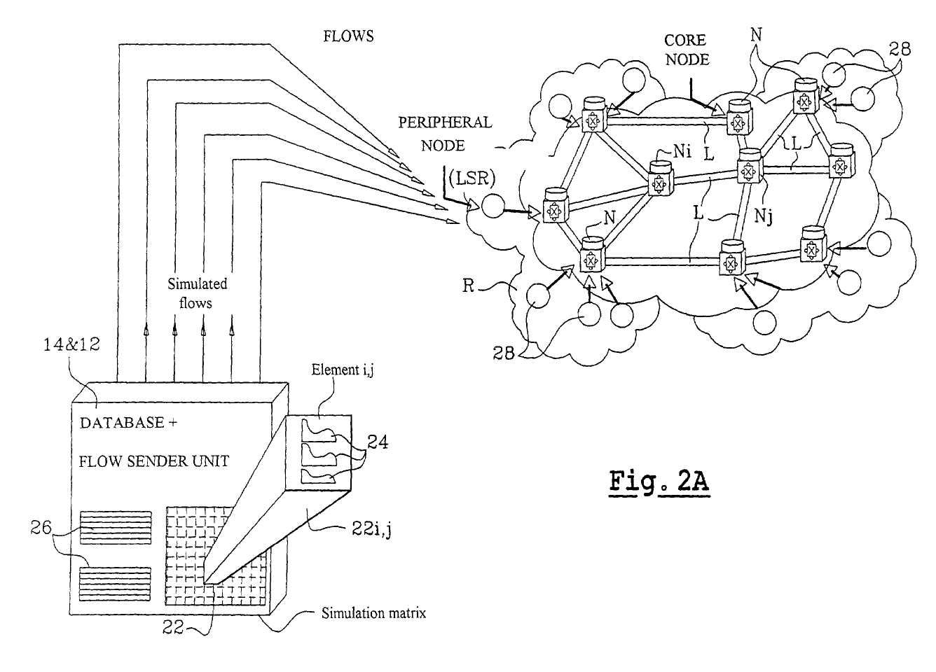

A first embodiment of the tool 2 for simulating a network or a set of networks, possibly with on-demand dimensioning, is described next with reference to the FIG. 2 diagram. In the following description, for simplicity, the term “network” is used generically whether it refers to a single network or to a plurality of networks, interconnected or not, taken into account by the tool 2. In the example shown, the network R is a wavelength division multiplex (WDM) optical network, the WDM technology enabling the same optical fiber to convey a plurality of different wavelengths. It is nevertheless to be understood that the tool 2 can be used for any other type of network.

The concept uses a new entity, namely the flow, rather than simulating propagation and managing each packet in the network. Simulation then consists in using methods of modeling the traffic distribution in the network by means of flows F. A flow F is an intermediate entity between the packet level and the level of intrinsic switching granularities. At the level of the network R, virtually all of the range of traffic variation can be handled by the dynamic creation of flows.

A flow is defined by one or more characteristics, such as: the distributions in time, i.e. start dates and end dates, and the spatial distribution, or the distribution of the flows in the network. It is also possible to take into account routing, based on traffic matrix analysis.

The phenomena that occur within the flows can be characterized in various ways. For example, one simple and effective approach to this characterization consists in allocating to the flow F:

a mean bit rate,

a variance, and

a qualitative parameter, in particular the class of service required by the flow in question.

The class of service can be the “premium” class for conveying voice or the “best effort” class for conveying data.

Characterizing the flows by the mean and the variance corresponds best to the bursty (sporadic) flows that are specific to data traffic. The simulation flows can also be applied to “self-similar” data types. In this case, the flow characterization parameters are preferably the mean and/or the “Hurst” parameter for measuring the degree of autocorrelation between the arrivals of packets.

In a circuit-type network, characterizing the flows is much simpler, since it is possible to simulate directly physical parameters that condition transmission, such as wavelength. The flows are then treated like wavelengths. The bit rate is therefore fixed, and only the spatial distribution and the temporal distribution of the flows are modified, not the internal characterization of the flow.

Depending on the timescale it is planned to simulate and the duration of use of the flows F, the flows can be representative of:

either the application at the lowest level, in which case it can be a question of traffic generated by a particular application (microflow),

or hypotheses which treat it as an aggregation of flows or microflows, in which case it can be a question a traffic system from a local area network (LAN).

Applying different targets in terms of volume, with or without aggregation, for different bit rates can be envisaged. Then the difference characterizes and packetizes two types of information, namely the manner in which performance is obtained at the level of the nodes and the manner in which it is used thereafter, which is subordinate to the data actually used to dimension the network following the simulation.

From the scientific point of view, it is more difficult to characterize reliably an aggregate than an isolated microflow, since aggregation generally implicates statistical multiplexing, buffer memory capacities, and other service disciplines concerning the nodes. This explains why the deterministic behavior of an aggregation of flows in a network is not envisaged in the prior art.

The simulation method uses for the flows F stochastic matrices 20 in which each member 22 expresses the mean traffic between two specific nodes N. The mean flow traffic is specified in terms of intensity distribution on a timescale which can be a long-term timescale, for example corresponding to a daily cycle of 24 hours. Thus the matrix 20 includes for each member 22 information that can be represented on an intensity distribution curve 24 from which a random drawing is effected with a local distribution in time.

FIG. 2B gives an example of the intensity distribution curve 24 for the member 22ij of the matrix 20 which, according to the column and row formatting of the matrix, relates to the flow Fij between the nodes N designated Ni and Nj (FIG. 2A). To simulate a network comprising a number E of nodes, the matrix 20 therefore includes a number E² of such members.

The intensity of the flow, in particular units, is plotted on the ordinate axis as a function of time plotted on the abscissa axis. The curve 24 shows in particular the modulation, i.e. the envelope, of the flow intensity variations, whose shape is smoothed over the period of the cycle (here 24 hours), which corresponds to the macroscopic scale.

However, the instantaneous value of the intensity of a flow is fixed by stochastic modeling. Accordingly, for a short period of the cycle, the intensity varies in a random or pseudorandom manner within constraints fixed by the modulation of the curve 24.

FIG. 2C represents by way of illustration and plotted on axes analogous to those of FIG. 2B, but on a microscopic scale (here 30 seconds), local variations in the intensity of the flow over a range VL of the curve 24, in order to cover intensity fluctuations over a period of the order of the duration of the flow in the network. Note that on this microscopic scale the variations can feature significant excursions.

Thus the traffic modeling matrix contains different timescales that are available according to whether evolution is considered on a macroscopic or microscopic timescale.

To be more specific, for each pair of nodes (for example the nodes Ni and Nj), the stochastic matrix 20 defines:

the modulation of the traffic distribution in the day (for a daily cycle), which corresponds to a first distribution on the macroscopic scale (FIG. 2B), and

the stochastic fluctuations quantified for successive short-time periods, which corresponds to the microscopic scale.

The stochastic fluctuations can be produced by pseudorandom drawing in accordance an exponential distribution of the duration of the flow, in particular in accordance with a Poisson or like distribution. To achieve these stochastic variations, the flow sender unit 12 includes random or pseudorandom drawing means which effect successive drawings in accordance with a periodicity that is sufficiently close in time to simulate realistic variations. Each drawing therefore gives rise to an instantaneous random variation, conforming to the Poisson distribution, of the intensity value of the flow indicated generally by the curve 24 on the macroscopic scale.

As a result, the curves of the intensity of the flow F do not yield deterministic flow members, but probabilities, in accordance with Poisson curves, for example, which is what confers on the flows F their stochastic nature.

Because the simulation process uses incoming stochastic flows F, the samples for determining the solidity of the network are also statistical.

Each member 22 of the matrix 20 contains analogous information that governs the arrivals of the stochastic flows from their respective pair of nodes.

Note that each node can be associated with information constituting several series, each associated with a type of flow between a pair of nodes to be modeled. Accordingly, in the FIG. 2A example, the member 22ij of the matrix 20 is represented as including three curves 24, each of which is analogous to that of FIGS. 2B and 2C and each of which is associated with a particular type of service.

In this way it is possible to simulate day/night effects on a large continental network whilst conforming to a realistic specification relating to arrivals of flows, connection requests, processing of “voice” or packet calls, etc.

This creates a basis for computation to be executed in accordance with traffic intensity hypotheses for a given day and in accordance with the short-term distributions.

Other qualitative and quantitative information used to characterize the flows F is shown diagrammatically by boxes 26 in the combination comprising the database and the flow sender unit 14, 12 in FIG. 2A. This complementary information can relate to:

the nature of the types of traffic,

the classes of services concerned, and

typical bit rates, typical durations and other parameters setting random drawing rules for forming the stochastic flows, etc.

For each member 22 of the matrix 20, the corresponding stochastic flow is extracted in this way so that it can be integrated in the node N concerned of the network R.

In this example the network comprises two types of nodes:

core nodes, which do not communicate directly with routers, but only with other nodes, and

edge nodes, shown by white patches 28 in FIG. 2A, which constitute access channels and are connected to routers, in this instance label switching routers (LSR).

These are IP routers which can also operate in the multi-protocol label switching (MPLS) mode, which is the current way to use the Internet with connection-oriented approaches. The LSR generate connection-oriented label switch passes (LSP) between two points, like the asynchronous transfer mode (ATM) or the frame relay technique. The flow concept used therefore faithfully respects the design of the network, since the latter uses virtual connections between two points that can also be characterized. Thus the approach of the invention lends itself naturally to the reality of present day networks.

In FIG. 2A, the system of routers 28 receives the various flows and distributes them in accordance with a routing algorithm of the network.

Moreover, if routers are not used, the hypotheses as to the places of entry of the flows into the network can be drawn up beforehand, followed by multiplexing and determining the necessary bandwidth.

Evaluating the bandwidth for the aggregate, in particular between an electronic network and an optical network, necessitates drawing up a wavelength map of the flows. This implies adaptation of the flows by interfaces at the interface between the router and the node with which it communicates.

The behavior of the network R is analyzed on the basis of the stochastic flows F produced by the flow sender unit 12 and using the data DF collected by the analyzer unit 16.

When the stochastic flows arrive in the network R, the capacity of the nodes (and where applicable of the links L) for processing them is observed. The processing capacity in question comprises not only the “raw” capacity but also, where applicable, “conversion” type functions for optical or like networks.

If the flow F cannot enter the network, the node causing the blockage is uprated using the dimensioning data DD from the modification unit 18.

On-demand dimensioning is achieved in this way, the demand being generated by the simulation flows.

For a representative sample, all these stochastic arrivals of flows in the network lead to dimensioning of the network to run the traffic hypotheses postulated at the outset.

Because of the statistical nature of the flow samples provided in the network, the process can be executed iteratively with samples that represent several cycles on the modeled timescale, for example 100 times a day. On each iteration, the matrix 20 emits flows whose intensity distribution on the macroscopic scale is the same (FIG. 2B), but with different local stochastic variations on the microscopic scale (FIG. 2C).

Iteration continues until a sufficient degree of confidence in the simulation is achieved. For each repeated simulation cycle, there is a large number of drawings (for example of the order of one million drawings). The level of confidence is therefore a function of the size of the sample and the number of cycles (i.e. the duration of the simulation).

Moreover, because the granularity conditions the quantity of flows to be simulated, the simulation time varies according to the granularity that is simulated (for example from a 10 Kbit/s microflow to several Mbit/s of aggregate traffic).

In a practical implementation, using existing processing means in this manner to simulate tens of millions of microflow sources to be subsequently aggregated and transported in the network can be envisaged.

The simulation on the basis of flows F can, among other things:

model the traffic transmitted by an application (voice, video, file transfer, HTTP, etc.),

model an aggregate of microflows (output of a local area network (LAN)), and

be specified by a set of traffic behavior modeling parameters (average rate of passage, sporadic character, mathematical models, MMP, self-similarities, CoS, VPN, etc.).

However, behavior at the packet level remains implicit and is not simulated, which signifies that the number of events to be simulated is lower by several orders of magnitude compared to packet level modeling as used in some standard approaches.

The properties of the flows can be managed as a function of many different distributions (arrivals of flows, durations of flows, destinations of flows, dynamic updating of parameters with transport control protocol (TCP), etc.

The simulation technique can be seen as incorporating the following steps:

i) introducing a simulation stochastic flow F into the network,

ii) detecting the performance of the network in relation to the stochastic flow F, and

iii) uprating any weak or inadequate parts of the network to process the imposed flow.

These steps can run interactively, with the uprating step iii) triggered automatically as a function of the detection step ii), the flow introduction step i) being able to run independently and concomitantly, in accordance with a particular program.

The simulation can be applied to a “virgin” network R, in other words one with a strict minimum of predefined characteristics (initial topology), characterized by a set of nodes N and of links L between them. The capacities of the nodes N and the links are not specified for the virgin network: there is only a network and node model with a set of limits, but with no capacity.

The idea is to use the stochastic flows F to introduce constraints into the network R to determine its requirements and modify the limits.

In response to the flow constraints, the respective capacities and functions of the network are updated on demand (by a targeted uprating of performance via the dimensioning data DD). This uprating must potentially take into account many parameters, such as the performance of the nodes at the packet level, quality of service, priorities, etc. Because of this, the dimensioning data DD is established not only as a function of the functioning data DF that has been collected but also as a function of external parameters, for example in accordance with a changing specification implicitly integrated into the flow.

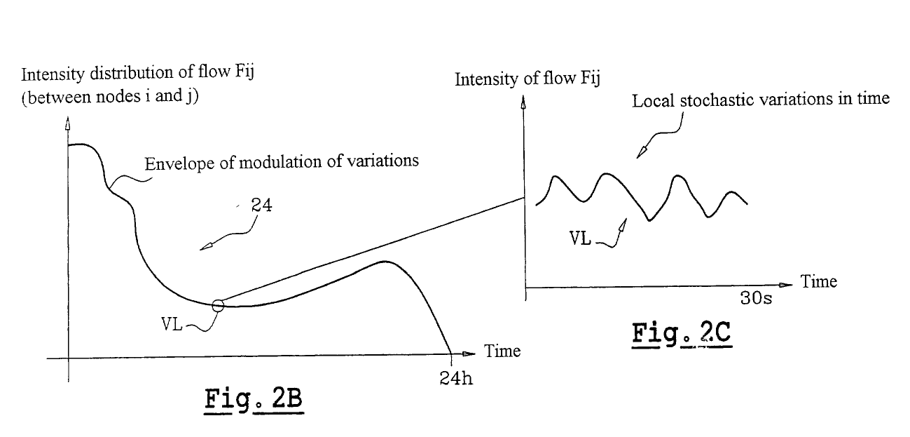

FIG. 3 shows diagrammatically the initially virgin network R from FIG. 2A after on-demand dimensioning by the process previously cited. Note that some of the nodes N and the links L have an uprated performance, in particular in terms of capacity, as indicated by the respective arrows RN and RL.

The dimensioning data DD is established in accordance with a particular protocol to indicate simultaneously: i) the location of the specific network to be dimensioned (designation of particular node(s) or link(s)), ii) the characteristic to which the dimensioning relates (capacity, speed, number of ports, etc.), and iii) the quantified characteristic (for example a percentage increase, a new capacity value, etc.). The dimensioning data can also specify the addition or the movement of a node or a link using a predefined signaling protocol.

Note that the invention is noteworthy for its ability to manage the network in the same way as using realistic management or traffic engineering techniques and protocols, even at the design stage.

This approach can be used to simulate any dynamic event tied to management, traffic control, faults (which impact on the architecture of the network), etc.

One typical action of dynamic dimensioning relates to the capacity for selectively uprating the capacity of the nodes N. This approach can take account of different uprating granularities, including that currently specified by the network manufacturer.

The approach according to the invention, based on an analysis of the flow, constitutes a solution that may be qualified as intermediate, continuing to conform to routing protocol dynamics and taking account of dynamic elements operative on the network, such as faults, traffic engineering algorithms, flow control, etc.

At present, the aim is to create “multi-granularity” networks in which the various layers and the various steps are integrated into the network, with aggregation to create traffic switched using different techniques.

The method according to the invention applies at the network construction stage protocols which at present are often adopted a posteriori. For example, if a load balancing technique is used in the network, there is a protocol whose function is to divide the traffic in order to distribute it over several paths. This technique can then be taken into account from the network dimensioning stage.

This is possible because the simulation applies to relatively fine entities to which real protocols can be applied.

There can further be provision for modifying the network structure dynamically as a function of the simulation, in particular by adding or removing nodes and links. This presupposes interaction between “off-line” and centralized mechanisms, not directly involved in the simulation process, and distributed on-line mechanisms operating in real time. In this case, an off-line analysis can be obtained via a node adapted accordingly, for example one provided with a function for analyzing the network status, and in particular the traffic distribution. The network topology can also be changed dynamically via this node, in particular by setting up at least one supplementary link between two nodes.

Compared to conventional techniques that simulate the network control plan only at the node level, the invention further predicts the plan of attack, with its impact on dimensioning, using the same tool and within the context of the same process.

In the embodiment with on-demand dimensioning, the tool is operative in two cases in particular:

in the case of a virgin network, as described above, in which it effects a complete on-demand dimensioning computation (since it enables real time supply of the means to be allocated to the various nodes), and

in the case of a network that has already been dimensioned, for which it uses only the performance of the various algorithms and protocols.

It is also possible to carry out looped simulations, in which the result from a network dimensioned during a previous simulation is the subject of further simulation, either with the same stochastic flows (apart from the random factor) or with new flow parameters. This looping can be repeated an arbitrary number of times until a network that is conformed for different flow possibilities is obtained.

This enables observation at the network on another, longer timescale, for example over a period of years, even though the flow matrix is based on daily cycles.

As a general rule, a dynamic traffic matrix is available which represents variations in time on a scale of one day. However, an operator often wishes to know how the network will evolve over a period of several years. When a network has been dimensioned on the basis of a given traffic matrix, it is possible to apply the hypothesis that a given number of months later the matrix will have evolved by a particular multiplier factor, for example. The process then starts again from the preceding result and the same principle of selectively uprating the performance of the nodes is applied, but starting from a given situation that is not a virgin network, namely one resulting from a first simulation.

This is possible because at the network level outputs can be inputs: nodes, protocols used, links, and physical parameters if necessary.

According to an optional aspect, the tool is also capable of simulating network faults dynamically. Using protection and restoration algorithms, faults are created randomly or exhaustively in the network that generate supplementary capacity requirements in the nodes and the links onto which the traffic will be rerouted. This aspect is taken into account in the simulation phase. In a dynamic simulation, the supplementary resources required are determined by restoration or protection scheme algorithms and applied in real time.

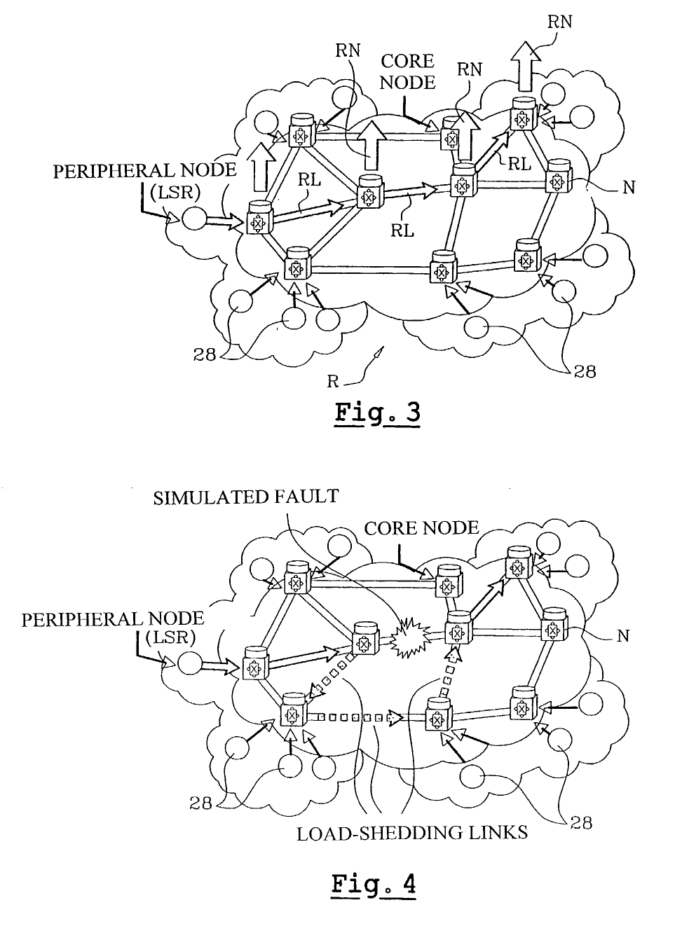

For example, FIG. 4 shows a fault simulated on a link between two core nodes of the network. In response to this, the routing over the network R imposes an overload on the load-shedding links that connect these two nodes. The analysis then aims to determine if these links and the nodes involved can handle this overload with the simulated flows.

The tool 2 can also be used for comparative studies of several approaches, with protection schemes applied differently in different networks.

Technical comparisons can also be obtained between a packet mode and a circuit mode for identical topologies and traffics, yielding cost comparisons taking account of the unit costs of the components used.

Accordingly, the tool can be used for scientific studies (analysis of new nodes, new types of nodes, functions offered, etc.), or as a tool for assisting an operator with network planning.

The invention applies to any flow transport network, the term “flow” being understood in the widest sense: it covers therefore not only the transport of computer and electronic data, but also the distribution of power or utilities (gas, electricity, telephone) or material goods, vehicle transport networks (rail, road, sea, air), monetary flows in a macroeconomic or microeconomic network (stocks and shares trading, transactions between banks, businesses, etc.), flow of parts or tasks in industry, etc.

The principle of the invention applies equally well to circuit type nodes, for example nodes which switch wavelengths in the case of an optical network, or packet switches.

In the case of the circuit mode, it is relatively simple to find out if a flow arriving at a node can be switched or not: to return to the example of an optical network, either a port suited to the wavelength of the incoming flow exists, in which case the flow is processed automatically, or the node does not have any such port and the flow is refused.

The situation is more complicated in the case of a packet switch, whether it is electronic or optical. In effect, when a flow arrives at a node, the latter needs to know the equivalent bandwidth of the incoming flow, plus that of the preceding flow, before it can determine if the incoming flow can transit through it. This is because statistical multiplexing, contention, packet level performance considerations, etc. are operative that do not exist at the circuit level. These aspects are taken into account by a tool for simulating the characteristics of the node as such. The information concerning the node required to improve its performance can be obtained analytically, by means of tables of results, by means of specific simulations, with differing degrees of approximation according to the performance, the techniques for which are known in the art.

The tool according to the invention can accept the above type of information as input, regardless of its source. The information preferably comes from a tool for analyzing the characteristics of the network, if one is available.

The invention is particularly well suited to connection-oriented applications. Dynamic account can be taken of congestion control mechanisms which change the parameters of the flow relative to observed states in the network in real time. This aspect is modeled by the behavior at the flow level, without descending to the packet level.

There follows a summary listing of a few of the advantages and features of the tool 2 according to the invention.

Added value for network strategy development:

pertinent results for the comparison and orientation of system and network architectures,

monitoring and management of the evaluation for existing or new protocol scenarios, and

efficacious and original design and planning methods that can be applied to models covering the short term or the long term.

Solutions for typical studies for creating complex networks:

taking account of dynamic aspects (traffic, real time mechanisms, etc.),

taking account of scales (terabit and network),

incorporating a large set of constraints (physical, conversion, protection, etc.), and

accepting any model of Internet working.

Dynamic flow simulator:

representing the distribution of the traffic in a network by means of flows,

a flow is an intermediate entity between a packet and the intrinsic switching granularities,

modeling the traffic transmitted by an application (voice, video, file transfer, HTTP, etc.),

modeling an aggregate of microflows (LAN output, etc.),

can be specified by a set of parameters modeling traffic behavior (average of rates of passage, sporadic nature, mathematical models, MMPP, self-similarities, etc.), CoS, VPN, etc.,

behavior at packet level remains implicit and is not simulated, which implies a reduction in the number of events to be simulated by several orders of magnitude, and

the properties of the flows can be managed in accordance with many distributions (flow arrivals, flow durations, flow destinations, dynamic updating of parameters with TCP, etc.).

Constraints applied to a network model by the stochastic application dynamic events and flows:

dimensioning on demand (DoD) of the capacity (and where applicable the configuration) of the network and its resources,

processing the successive flows in the network (routing, distribution, etc.),

uprating the corresponding resources required relative to the service, the protocols or any other design constraint,

any optimization can be added at this stage: i.e. a time consuming optimization (optimization of topology, etc.), constraints or anticipation of a future operation of the network using the “point and click” technique, VPN, etc.,

real time behavior of the “life” of network(s),

utilization based on existing resources,

application of survival scenarios and traffic engineering mechanisms (dynamic procurement, “intelligent” routing, dynamic adjustment, load balancing, traffic partitioning, congestion management, signaling protocols, etc.),

preliminary evaluation of performance at packet level,

dynamic impacts visible at the edges of the network, with performance of the edges for evaluating equivalent resources,

possibility of uprating the resources of the network to suit the “exact” requirements,

updating the status of the network with new flows,

applicable to a wide range of routing and procurement algorithms and protocols,

node status database,

uprating of the dimensioning and functions of nodes relative to constraints in terms of service, uprating of systems (transmission and switching), evaluation of performance required for OPS/OBS routers, any type of packet/frame router or switch, and

taking account of any dynamic event related to the “life” of the network: traffic engineering, faults, etc.

Potential of dynamic flow simulation:

comparing network solutions (cost, performance, etc.),

systems (packet vs. circuit), multigranularity, etc.,

architecture (pair vs. overlayers, topologies, etc.)

protocol and traffic engineering,

evaluating potential transparency in the network,

evaluating conversion requirements,

evaluating restoration performance,

comparing survival strategies (quantity of resources to be added),

determining the improvement with dynamic procurement at different granularities,

yield of congestion control mechanisms in terabit networks, and

compatibility with future developments (independence of model elements and methods).

It will be understood from the foregoing description that the invention has many different embodiments and variants.

What is claimed is:

1. A method of simulating the behavior of a network including a set of network elements, which method consists in:
producing and introducing into the network a parametered flow intended to simulate a constraint on a network element, and
detecting the behavior of the network in response to a constraint imposed by said flow.

2. A method according to claim 1, wherein the flow is produced on the basis of modeling the variation in time of the traffic intensity in the network in relation to the or each element to which a flow is addressed in the context of the simulation.

3. A method according to claim 1, wherein the flow is produced in the form of a set of flows, each member of which set corresponds to the traffic on an elementary path portion connecting a specified respective pair of nodes of the network.

4. A method according to claim 1, including a step of producing a matrix of flows, each member of which matrix expresses a variation in time of the flow intensity on a respective path portion of the network, the flows being introduced into the network in accordance with said matrix.

5. A method according to claim 1, wherein a stochastic variation is imposed on the flow.

6. A method according to claim 1, wherein the flow expresses a traffic intensity variation on a macroscopic timescale relative to its transit time in the network.

7. A method according to claim 6, wherein the variation applies to evolutions of flow on a macroscopic timescale simulating several hours of real use of the simulated network, in particular over a daily operating cycle of the network.

8. A method according to claim 6, wherein an intensity modulation on a macroscopic scale is created for a flow, onto which are imposed local stochastic variations of the flow on a microscopic timescale (FIG. 2C).

9. A method according to claim 5, wherein the stochastic variation of the flow is established in accordance with an exponential distribution, preferably a Poisson distribution.

10. A method according to claim 1, wherein the flow is characterized by one or more of the following parameters:
a mean bit rate,
the variance of the bit rate,
the Hurst parameter, and
a qualitative parameter, in particular the class of service required by the flow.

11. A method according to claim 1, further including the steps of:
identifying any weakness of an element faced with said constraint, and
if necessary, modifying an element bearing witness to said weakness to allow it to accommodate the constraint that revealed it, in particular by uprating the dimensioning of a performance characteristic of the element.

12. A method according to claim 11, wherein said detection, identification and modification steps are executed concomitantly with the introduction of flows into the network.

13. A method according to claim 1, wherein the network element is a node and/or a link.

14. A method according to claim 1, wherein the introduction of flows into the network is iterated at least once to simulate on each iteration a statistical variation of the flow obtained in particular on the basis of the stochastic nature of the flow.

15. A method according to claim 11, when executed to establish the dimensioning of the performance of an initially virgin network for which a topology of nodes and links is specified, wherein a flow in relation to which the network must be dimensioned is introduced into the network and said detection, identification and modification steps are carried out until the dimensioning conforming to the flow is obtained.

16. A method according to claim 11, when executed to establish a new dimensioning of the performance of an existing network, wherein a flow in relation to which it must be dimensioned is introduced into the network and said detection step and where applicable said identification and modification steps are executed until an updated dimensioning conforming to the flow is obtained.

17. A method according to claim 11, when executed to establish a dimensioning of the performance of a network faced with a simulated fault, wherein the network modified by the fault is simulated, a flow in relation to which the network modified in this way must be dimensioned is introduced into the network, and said detection step and where applicable said identification and modification steps are executed until there is obtained a dimensioning conforming to the flow on the modified network.

18. A method according to claim 1, the method being used to simulate a packet mode data transport network.

19. A method according to claim 18, wherein the flow is produced with an intermediate granularity.

20. A method according to claim 1, the method being used to simulate a circuit mode data transport network.

21. A system for simulating the behavior of a network including a set of network elements, wherein the system includes:
means for producing and introducing into the network a parametered flow intended to simulate a constraint on a network element, and
means for detecting the behavior of the network in response to a constraint imposed by said flow.

22. A system according to claim 21, including means for modeling the variation in time of the traffic intensity in the network in relation to the or each element to which a flow is addressed in the context of the simulation.

23. A system according to claim 21, including means for producing the flow in the form of a set of flows, each member of which set corresponds to the traffic on an elementary path portion connecting a specified respective pair of nodes of the network.

24. A system according to claim 21, including means for imposing a stochastic variation on the flow.

25. A system according to claim 21, wherein the flow expresses a traffic intensity variation on a macroscopic timescale relative to its transit time in the network.

26. A system according to claim 25, wherein the variation relates to flow evolutions on a macroscopic timescale simulating several hours of real use of the simulated network, in particular over a daily operating cycle of the network.

27. A system according to claim 25, including means for creating an intensity modulation of the flow on a macroscopic scale and means for imposing local stochastic variations of the flow on a microscopic timescale.

28. A system according to claim 24, wherein the means for imposing the stochastic variation produce a variation conforming to an exponential distribution, preferably a Poisson distribution.

29. A system according to claim 21, further including:
means for identifying any weakness of an element faced with said constraint, and
means for modifying an element bearing witness to said weakness to enable it to accommodate the constraint that revealed it, in particular by uprating the dimensioning of a performance characteristic of the element.

30. A system according to claim 21, wherein the flow has an intermediate granularity between the granularity of packets transported by the network and the intrinsic switching granularities of the network.
